(19) United States
(12) Patent Application Publication
(10) Pub. No.: US 2005/0174032 A1
(43) Pub. Date: Aug. 11, 2005

(54) Cathode-ray tube

(75) Inventors: Norio Shimizu, Tokyo (JP); Munechika Tani, Tokyo (JP); Fumiaki Nihei, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/106,558

(22) Filed: Apr. 15, 2005

Related U.S. Application Data
(63) Continuation-in-part of application No. PCT/JP04/10371, filed on Jul. 14, 2004.

(30) Foreign Application Priority Data
Jul. 23, 2003 (JP) 2003-200414

(51) Int. Cl. H01J 29/80

(52) U.S. Cl. 313/402

(57) ABSTRACT

A shadow mask has a major axis H and a minor axis V that intersect at right angles with each other, and a curvature along the major axis is set to satisfy the following relationships,
Cxm0<Cxmv, and Cxmd<Cxmh where Cxm0 is a curvature at an origin O where the major axis and the minor axis intersect at right angles, Cxmv is a curvature at a point (0, Ymvi) that is located towards a long side from a point of at least ¾ of a distance from the origin on the minor axis to an end of an effective dimension, Cxmh is a curvature at a point (Xmhi, 0) that is located in a region of 2/4 to ¾ of a distance from the origin on the major axis to an end of an effective dimension, and Cxmd is a curvature at a coordinate point (Xmhi, Ymvi).

### CROSS REFERENCE TO RELATED APPLICATIONS

This is a Continuation-in-Part Application of PCT Application No. PCT/JP2004/010371, filed Jul. 14, 2004, which was published under PCT Article 21(2) in Japanese.

This application is based upon and claims the benefit of priority from prior Japanese Patent Application No. 2003-200414, filed Jul. 23, 2003, the entire contents of which are incorporated herein by reference.

### BACKGROUND OF THE INVENTION

1. Field of the Invention

The present invention relates to a cathode-ray tube, and more particularly to a color cathode-ray tube with a shadow mask that is capable of improving display quality at low cost.

2. Description of the Related Art

In a color cathode-ray tube including a shadow mask, in order to display a color image with no color misregistration on a phosphor screen, it is necessary that three electron beams, which have passed through electron beam passage holes in the mask body of the shadow mask, exactly land on the associated three-color phosphor layers on the phosphor screen. To achieve this, it is necessary to precisely dispose the shadow mask at a predetermined position relative to the panel. In other words, it is necessary to precisely and properly set the distance (q-value) between the panel and the shadow mask.

In order to properly set the q-value, it is ideal to set the pitch of the three color phosphor layers as follows. That is, in a case where the three color phosphor layers are arranged in stripes in a predetermined order (e.g. red (R), green (G), blue (B), red (R), . . . ) and an interval between same-color phosphor layers is PHp, a distance d between two of the three phosphor layers should ideally be set at d=(⅔)PHp.

However, if the q-value is not properly set relative to the phosphor layer pitch PHp, it is not possible to secure an adequate width of each of black non-emission layers that are arranged between the phosphor layers. At the time of an operation for displaying a color image, degradation in color purity tends to occur. In addition, if the phosphor layer pitch PHp is large, the adequate width of the black non-emission layer is secured. However, if the phosphor layer pitch PHp is too large, the resolution would deteriorate.

In recent years, in order to enhance the visibility of color cathode-ray tubes, there is a demand for a decrease in curvature (i.e. an increase in radius of curvature) of the outer surface of the panel to a level of a flat plane. Accordingly, it becomes necessary to similarly decrease the curvature of the inner surface of the panel from the standpoint of the prevention of explosion and the visibility. Further, in order to cause the electron beams to exactly land on the phosphor layers on the inner surface of the panel, it is necessary to properly set the q-value, as mentioned above. Moreover, the curvature of the mask body having electron beam passage holes needs to be decreased in accordance with the inner surface of the panel (see, e.g. Jpn. Pat. Appln. KOKAI Publication No. 11-288676).

In the case of a shadow-mask type color cathode-ray tube, because of its operational principle, the amount of electron beams, which reach the phosphor screen through the electron beam passage holes in the shadow mask, decreases to less than ⅓ of the total amount of electron beams that are emitted from the electron gun assembly. Electron beams, which do not reach the phosphor screen, strike those parts of the shadow mask, which are other than the areas of the electron beam passage holes, and change to thermal energy to heat the shadow mask.

The resultant thermal expansion causes so-called doming, by which the shadow mask protrudes toward the phosphor screen. If the distance, i.e. q-value, between the phosphor screen and shadow mask exceeds a tolerable range due to the doming, beam landing errors occur on phosphor layers. Consequently, the electron beam shifts beyond the black non-emission layer and causes the phosphor layer of a color, which is not the intended color for light emission, to emit light, leading to degradation in color purity.

The amount of beam mislanding due to the thermal expansion of the shadow mask varies greatly depending on the luminance of an image pattern that is to be displayed, or the duration time of display of the pattern. In particular, when a high-luminance image pattern is locally displayed, local doming occurs and a local beam mislanding occurs in a short time period.

The beam mislanding due to the local doming becomes most conspicuous when a high-luminance pattern is displayed on a region that is apart from the center of the screen in the major-axis direction by a distance corresponding to about ⅓ of the distance between the paired short sides (i.e. the entire width in the major-axis direction). Thus, the amount of beam mislanding is greatest at the intermediate part of the screen.

However, if the curvature of the mask body is decreased, the mechanical strength of the mask body also decreases and the amount of doming becomes too great to be negligible. Such deformation of the mask body leads to beam mislanding. Owing to the beam mislanding, the electron beam shifts beyond the black non-emission layer and causes the phosphor layer of the color, which is not the intended color for light emission, to emit light, resulting in degradation in color purity.

In order to suppress the doming, shadow masks of color cathode-ray tubes with nearly flat panels, in most cases, are formed of an alloy comprising essentially of iron and nickel as a material with a low thermal expansion coefficient. For example, in many cases, shadow masks are formed of, e.g. 36Ni invar. This material has a thermal expansion coefficient of 1 to 2×10⁻⁶ in the temperature range of 0 to 100° C. and is robust to doming. However, this material is expensive and the iron-nickel alloy has a high resiliency after annealing. It is thus difficult to perform a curved-surface forming process and to obtain a desired curved surface.

For example, even if annealing is performed at a high temperature of 900° C., the yield-point strength is about 28×10⁷ N/m². In order to obtain a yield-point strength of 20×10⁷ N/m² or less, which is generally considered to permit an easy forming process, it is necessary to perform annealing at very high temperatures. In particular, a color cathode-ray tube with a flat panel surface has a small curvature of the mask body, so a forming process is still more difficult.

In a case where the forming process is inadequately performed and undesirable residual stress remains after the forming process, the residual stress varies in the fabrication process of the color cathode-ray tube, resulting in deformation of the curved surface. Consequently, beam mislanding occurs.

On the other hand, when a material comprising iron as a principal component, the yield-point strength can be set at 20×10⁷ N/m² or less by the annealing at about 800° C. It is thus very easy to perform a forming process, and there is no need to keep at high temperatures the mold temperature for the forming process, which is indispensable in the case of the invar alloy. Therefore, the productivity is also increased. However, the thermal expansion coefficient is high, i.e. about 12×10⁻⁶, in the temperature range of 0 to 100° C. Thus, this material is disadvantageous in terms of doming, and the degradation in color purity is a problem at the time of operation of the color cathode-ray tube.

As has been described above, when the curvature of the outer surface of the panel is reduced in order to improve the visibility, an increase in cost is incurred if the shadow mask is formed of a material with a low thermal expansion coefficient. In addition, if such a material is used, the forming of the curved surface of the mask body becomes difficult due to the undesirable residual stress after formation, and the desired curved surface may not be obtained. Consequently, in the cathode-ray tube having such a shadow mask, a beam landing error would occur and the quality in display would deteriorate.

Besides, if an inexpensive material, which has a relatively high thermal expansion coefficient, is used to form the shadow mask, local doming tends to occur in the mask body at the time of operation and beam mislanding may occur. Consequently, in the case of the color cathode-ray tube having such a shadow mask, the quality in display may deteriorate due to degradation in color purity.

### BRIEF SUMMARY OF THE INVENTION

The present invention has been made in consideration of the above-described problem, and the object of the invention is to provide a cathode-ray tube that is capable of improving display quality at low cost.

According to a first aspect of the invention, there is provided a cathode-ray tube comprising:
an envelope including a substantially rectangular panel with a substantially flat outer surface, and a funnel that is coupled to the panel;
a phosphor screen that is disposed on an inner surface of the panel;
an electron gun assembly that is disposed within the envelope and emits an electron beam towards the phosphor screen; and
a substantially rectangular shadow mask including a mask body, which is disposed to face the phosphor screen and has a plurality of electron beam passage holes, and a mask frame that supports a peripheral part of the mask body,
wherein the shadow mask is formed of a material that essentially comprises iron,
the shadow mask has a major axis and a minor axis that intersect at right angles with each other, and a curvature along the major axis is set to satisfy the following relationships,
   Cxm0<Cxmv, and Cxmd<Cxmh
where Cxm0 is a curvature at an origin (0, 0) where the major axis and the minor axis intersect at right angles; Cxmv is a curvature at a point (0, Ymvi) that is located towards a long side from a point of at least ¾ of a distance from the origin on the minor axis to an end of an effective dimension; Cxmh is a curvature at a point (Xmhi, 0) that is located in a region of 2/4 to ¾ of a distance from the origin on the major axis to an end of an effective dimension; and Cxmd is a curvature at a coordinate point (Xmhi, Ymvi), and
the shadow mask is configured to satisfy the following relationship,
   Zmhi<Xmhi²×Zmho/Xmho²
where Xmho is a distance between the origin on the major axis and the end of the effective dimension; Zmho is a difference in height along a tube axis between the origin on the major axis and the end (Xmho, 0) of the effective dimension; and Zmhi is a difference in height along the tube axis between the origin on the major axis and a point (Xmhi, 0).

According to a second aspect of the invention, there is provided a cathode-ray tube comprising:
an envelope including a substantially rectangular panel with a substantially flat outer surface, and a funnel that is coupled to the panel;
a phosphor screen that is disposed on an inner surface of the panel;
an electron gun assembly that is disposed within the envelope and emits an electron beam towards the phosphor screen; and
a substantially rectangular shadow mask including a mask body, which is disposed to face the phosphor screen and has a plurality of electron beam passage holes, and a mask frame that supports a peripheral part of the mask body,
wherein the inner surface of the panel has a major axis and a minor axis that intersect at right angles with each other, and a curvature along the major axis is set to satisfy the following relationships,
   Cxp0<Cxpv, and Cxpd<Cxph
where Cxp0 is a curvature at an origin (0, 0) where the major axis and the minor axis intersect at right angles; Cxpv is a curvature at a point (0, Ypvi) that is located towards a long side from a point of at least ¾ of a distance from the origin on the minor axis to an end of an effective dimension; Cxph is a curvature at a point (Xphi, 0) that is located in a region of 2/4 to ¾ of a distance from the origin on the major axis to an end of an effective dimension; and Cxpd is a curvature at a coordinate point (Xphi, Ypvi), and
the inner surface of the panel is configured to satisfy the following relationship,
   Zphi<Xphi²×Zpho/Xpho²
where Xpho is a distance between the origin on the major axis and the end of the effective dimension; Zpho is a difference in height along a tube axis between the origin on the major axis and the end (Xpho, 0) of the effective dimension; and Zphi is a difference in height along the tube axis between the origin on the major axis and a point (Xphi, 0).

According to the cathode-ray tube with the above-described structure, the shadow mask is formed of a material that essentially comprises relatively inexpensive iron, so the cost can be reduced. In addition, since the curvature of the shadow mask is set at a proper condition, the mechanical strength of the mask body can be improved and occurrence of local doming can be prevented. Thereby, a beam landing error due to deformation of the mask body can be suppressed, and deterioration in display quality due to degradation in color purity can be prevented.

Besides, in order to precisely and properly set the distance between the panel and the shadow mask, the shadow mask is formed to have a shape similar to the shape of the inner surface of the panel. Thus, also by setting the curvature of the inner surface of the panel at a proper condition, the mechanical strength of the mask body can be improved and occurrence of local doming can be prevented. Thereby, a beam landing error due to deformation of the mask body can be suppressed, and deterioration in display quality due to degradation in color purity can be prevented.

### BRIEF DESCRIPTION OF THE SEVERAL VIEWS OF THE DRAWING

FIG. 1 schematically shows the structure of a color cathode-ray tube according to an embodiment of the present invention;

FIG. 2 is a plan view that schematically shows the structure of a phosphor screen of the color cathode-ray tube shown in FIG. 1;

FIG. 3 is a view for explaining the trajectories of electron beams in the color cathode-ray tube shown in FIG. 1;

FIG. 4 is a plan view that schematically shows the structure of a shadow mask in the color cathode-ray tube shown in FIG. 1;

FIG. 5 shows an example of a distribution of curvatures along the major axis of the inner surface of the panel;

FIG. 6 is a view for explaining a schematic curved-surface shape of the inner surface of the panel;

FIG. 7 shows an example of a distribution of curvatures along the major axis of the shadow mask;

FIG. 8 is a view for explaining a schematic curved-surface shape of the shadow mask;

FIG. 9 is a view for explaining mislanding of an electron beam due to doming;

FIG. 10 is a graph that shows an example of the relation of the amount of mislanding due to doming, relative to the number of orders of a function that defines the cross-sectional shape along the major axis;

FIG. 11 is a graph that shows an example of the relation of curvature along the minor axis, relative to the coordinate values on the major axis of the mask body;

FIG. 12 is a graph that shows an example of the relation of the interval between electron beam passage holes, relative to the coordinate values on the major axis of the mask body;

FIG. 13 is a graph that shows an example of the relation of curvature along the minor axis, relative to the coordinate values on the major axis of the inner surface of the panel;

FIG. 14 is a view that shows an example of a distribution of curvatures along the major axis of the mask body at respective positions on the mask body in a first embodiment;

FIG. 15 is a view that shows an example of a distribution of curvatures along the minor axis of the mask body at respective positions on the mask body in the first embodiment;

FIG. 16 is a view that shows an example of a distribution of curvatures along the major axis of the panel at respective positions on the panel in the first embodiment;

FIG. 17 is a view that shows an example of a distribution of curvatures along the minor axis of the panel at respective positions on the panel in the first embodiment;

FIG. 18 is a view that shows an example of a distribution of curvatures along the major axis of the mask body at respective positions on the mask body in a second embodiment;

FIG. 19 is a view that shows an example of a distribution of curvatures along the minor axis of the mask body at respective positions on the mask body in the second embodiment;

FIG. 20 is a view that shows an example of a distribution of curvatures along the major axis of the panel at respective positions on the panel in the second embodiment; and

FIG. 21 is a view that shows an example of a distribution of curvatures along the minor axis of the panel at respective positions on the panel in the second embodiment.

### DETAILED DESCRIPTION OF THE INVENTION

A cathode-ray tube according to an embodiment of the present invention will now be described with reference to the accompanying drawings.

As is shown in FIG. 1, the color cathode-ray tube includes an envelope (vacuum envelope) 20 that is formed of glass. The envelope 20 includes a substantially rectangular panel 3 and a funnel 4 that is integrally coupled to the panel 3. The panel 3 includes a substantially rectangular effective portion 1 and a skirt portion 2 that extends upright along a tube axis Z from a peripheral part of the effective portion 1. The funnel 4 is coupled to the skirt portion 2. An axis extending through the central part of the effective portion 1 in a direction substantially perpendicular to the panel 3 is defined as the tube axis Z. An axis intersecting at right angles with the tube axis Z is defined as a horizontal axis (major axis) X, and an axis intersecting at right angles with the tube axis and horizontal axis X is defined as a vertical axis (minor axis) Y.

The outer surface of the effective portion 1 of the panel 3 is formed substantially flat so as to have a radius of curvature of 10,000 mm or more. The inner surface of the effective portion 1 is formed of a spherical surface or an arbitrary aspherical curved surface. The skirt portion 2 has stud pins 16, which project inward at corner portions of the inner part of the skirt portion 2 or near the horizontal axis or vertical axis of the inner part of the skirt portion 2.

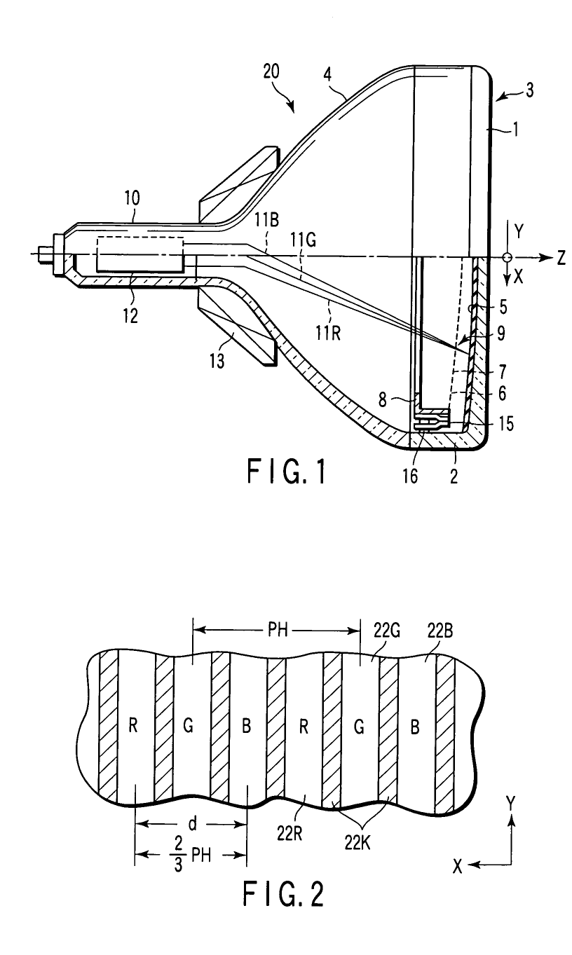

A phosphor screen 5 is disposed on the inner surface of the effective portion 1 of panel 3. As is shown in FIG. 2, the phosphor screen 5 includes striped three-color phosphor layers 22 (R, G, B), which emit red (R), green (G) and blue (B) light and extend in parallel with the vertical axis Y, and striped black non-emission layers 22K, which are provided between the phosphor layers 22 (R, G, B).

The three-color phosphor layers 22 (R, G, B) are substantially equidistantly arranged along the horizontal axis X in a predetermined order of, e.g. red (R), green (G), blue (B), red (R),. . . . In a case where a distance between same-color phosphor layers (distance between green phosphor layers 22G in FIG. 2) is PH, a distance d between two of the three phosphor layers (distance between the centers of red phosphor layer 22R and blue phosphor layer 22B in FIG. 2) is set to be d=(⅔)PH.

An in-line electron gun assembly 12 is disposed within a cylindrical neck 10 that corresponds to a small-diameter part of the funnel 4. Specifically, the electron gun assembly 12 is disposed substantially coaxial with the tube axis Z that corresponds to the center axis of the neck 10. The electron gun assembly 12 emits three electron beams 11 (R, G, B), which are arranged in line in the same plane, toward the phosphor screen 5.

A shadow mask 9 that has a color selection function is disposed to face the phosphor screen 5 within the vacuum envelope 20. The shadow mask 9 includes a substantially rectangular mask body 7, which is disposed to face the phosphor screen 5, and a substantially rectangular mask frame 8 with an L-shaped cross section, which supports a peripheral part of the mask body 7. The mask body 7 includes a substantially rectangular effective region with a plurality of slit-like electron beam passage holes 6, through which electron beams 11 (R, G, B) pass.

The shadow mask 9 is detachably supported on the panel. Specifically, elastic support members 15 with substantially wedge shapes, which are attached to side surfaces of corner portions of the mask frame 8 or to side surfaces near the horizontal axis and vertical axis of the mask frame 8, are engaged with the stud pins 16. Thus, the mask body 7 is supported inside the panel 3 so as to face the phosphor screen 5 with a predetermined distance.

A deflection yoke 13 is attached to the outer surface of the funnel 4, which extends from the large-diameter part of the funnel 4 to the neck 10. The deflection yoke 13 generates non-uniform deflection magnetic fields that deflect the three electron beams 11 (R, G, B), which are emitted from the electron gun assembly 12, in the direction of horizontal axis and the direction of vertical axis. The non-uniform deflection magnetic fields comprise a horizontal deflection field with a pincushion shape and a vertical deflection field with a barrel shape.

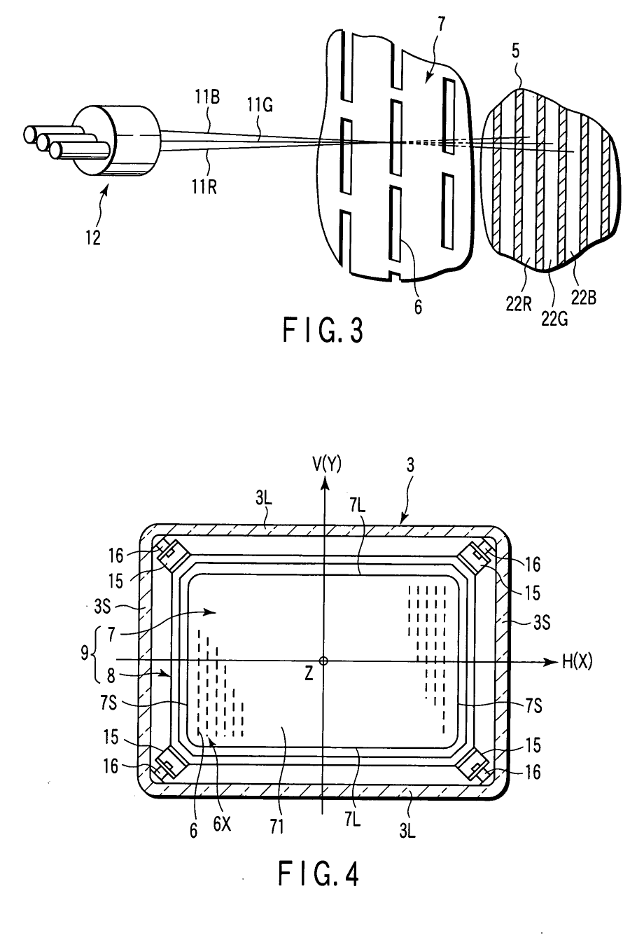

In the color cathode-ray tube with the above-described structure, the three electron beams 11 (R, G, B) are emitted from the electron gun assembly 12 toward the phosphor screen 5, as shown in FIG. 3, and are focused on the associated phosphor layers, while they are being self-converged near the electron beam passage holes 6. The three electron beams 11 (R, G, B) are deflected by the non-uniform deflection magnetic fields that are generated by the deflection yoke 13, and are horizontally and vertically scanned over the phosphor screen 5 via the electron beam passage holes 6 that are formed in the shadow mask 9. Thus, a color image is displayed.

As is shown in FIG. 4, the shadow mask 9 has a major axis H and a minor axis V that intersect at right angles. Specifically, the shadow mask 9 has the major axis H corresponding to the horizontal axis X of the panel 3, and the minor axis V corresponding to the vertical axis Y of the panel 3. These major axis and minor axis cross each other at the intersection between the mask body 7 and the tube axis Z, that is, at the origin.

The mask body 7 includes a substantially rectangular mask major surface (effective region) 71 with a plurality of electron beam passage holes 6. The mask body 7 has a pair of long sides 7L that are substantially parallel to the major axis H, and a pair of short sides 7S that are substantially parallel to the minor axis V. The panel 3 has a pair of long sides 3L that are substantially parallel to the horizontal axis X, and a pair of short sides 3S that are substantially parallel to the vertical axis Y. The mask major surface 71 is formed in such a curved shape as to generally project toward the phosphor screen 5.

Each of the electron beam passage holes 6 has a vertically elongated shape with a major axis extending in the minor-axis direction. The electron beam passage holes 6 are arranged in a substantially aligned fashion in the minor-axis direction with a predetermined pitch. Thus, electron beam passage hole trains 6X are formed. The electron beam passage hole trains 6X are arranged in parallel in the major-axis direction with predetermined intervals.

In this case, in order to display an image, which is free from color misregistration, on the phosphor screen 5 of the color cathode-ray tube, it is necessary that the electron beams, which pass through the electron beam passage holes 6 in the mask body 7, land exactly on the three-color phosphor layers of the phosphor screen 5. To achieve this, the positional relationship between the panel 3 and shadow mask 9 needs to be exactly maintained.

In addition, in order to enhance the visibility of the color cathode-ray tube, the outer surface of the panel 3 is, in usual cases, formed in a substantially flat shape (with a radius of curvature of about 10 m or more). Accordingly, the curvature of the mask body 7 needs to be decreased. However, when the mask body 7 with a small curvature is to be formed, if a material with a low thermal expansion coefficient is used, the cost increases and it becomes difficult to form a curved surface.

To solve this problem, in the present embodiment, the mask body 7 is formed using a material that essentially comprises relatively inexpensive iron. Thereby, it is possible to remarkably improve the performance in formation of a curved surface at low cost. However, the material that essentially comprises relatively inexpensive iron has a high thermal expansion coefficient. When a high-luminance image pattern is locally displayed, local doming occurs and the amount of a local beam landing error increases in a short time.

A countermeasure to deal with this problem is to increase the curvature of the inner surface of the panel 3 as great as possible. In this case, however, there arise problems with the manufacture of the panel 3 and problems of degradation in luminance due to an increase in thickness of the peripheral part.

Taking these problems into account, a color cathode-ray tube according to a first embodiment of the invention is configured as follows. By way of example, a description is given of a color cathode-ray tube wherein the diagonal effective diameter of the effective portion 1 is 51 cm, the aspect ratio is 4:3, and the radius of curvature of the outer surface of the panel is 20 m. The outer surface of the panel 3 is sufficiently planarized, as mentioned above, and the wall thickness of the panel 3 is set such that a difference in thickness between its central part and its peripheral part is within a range of 8 mm to 15 mm. In the first embodiment, the difference in thickness is set at about 11 mm.

The mask body 7 is formed of a material that essentially comprises iron with a thermal expansion coefficient of 12×10⁻⁶ in a temperature range of 0° C. to 100° C. Although the material is inexpensive, even if the panel is planarized, a sufficient performance of formation is secured. The diagonal effective dimension of the effective region 71 of the mask body 7 is about 50 cm, the minor-axis effective dimension is about 30 cm, and the major-axis effective dimension is about 40 cm.

As regards the panel 3, a curvature Cxp along the major axis X is set as shown in FIG. 16, and a curvature Cyp along the minor axis Y is set as shown in FIG. 17. In FIG. 16 and FIG. 17, the abscissa indicates positions on the major axis of the panel and the ordinate indicates positions on the minor axis of the panel. FIG. 16 and FIG. 17 show curvatures at the respective positions on the panel.

The inner surface of the panel 3 has the major axis (horizontal axis) X and the minor axis (vertical axis) Y that intersect at right angles with each other. The curvature along the major axis X is set to satisfy the following relationships,
Cxp0<Cxpv, and Cxpd<Cxph
where Cxp0 is a curvature at the origin (0, 0) where the major axis X and minor axis Y intersect at right angles; Cxpv is a curvature at a point (0, Ypvi) that is located towards the long side 3L from a point of at least ¾ of the distance (about 150 mm in this example) between the origin (0, 0) on the minor axis Y and the end of the effective dimension (i.e. long side 3L); Cxph is a curvature at a point (Xphi, 0) that is located in a region of 2/4 to ¾ of the distance (about 200 mm in this example) from the origin (0, 0) on the major axis X to the end of the effective dimension (i.e. short side 3S); and Cxpd is a curvature at a coordinate point (Xphi, Ypvi). Assume that the coordinate value at each point corresponds the distance (mm) from the origin.

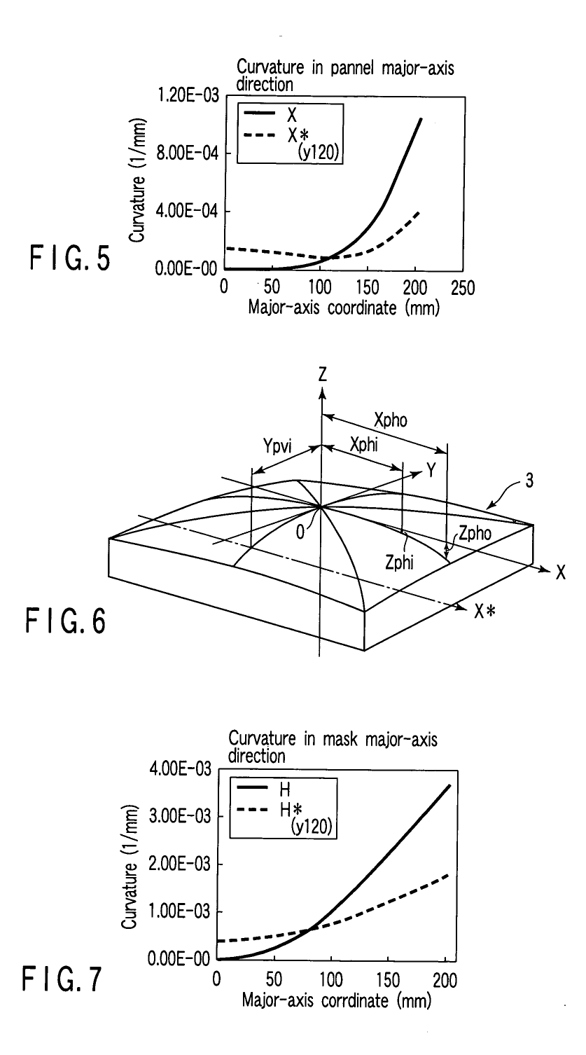

FIG. 5 shows an example of a distribution of curvatures in a direction along the major axis X of the inner surface of the panel 3. In FIG. 5, the abscissa indicates coordinate values (mm) on the major axis X (the origin is X=0), and the ordinate indicates a curvature (1/mm), i.e. an inverse number of the radius of curvature. The distribution of curvatures on the major axis X is indicated by a solid line, and the distribution of curvatures on a parallel axis X* that is parallel to the major axis X is indicated by a broken line. The parallel line X* is an axis that passes through a point (0, Ypvi) that is located towards the long side 3L from a point of at least ¾ of the distance between the origin on the minor axis Y and the end of the effective dimension. In this example, the parallel axis X* is defined as an axis that passed through a point (0, 120) where Ypvi=120. In addition, in this example, the point (Xphi, 0) that is located in a region of 2/4 to ¾ of the distance from the origin on the major axis X to the end of the effective dimension is set at a point (120, 0) where Xphi=120, and the coordinate point (Xphi, Ypvi) is set at a point (120, 120).

As is shown in FIG. 5, the curvature along the major axis X is nearly 0 at a central part of the screen near the origin (0, 0) on the major axis X (solid line), and gradually increases from an intermediate part including a midpoint (X=100) between the origin and the short side 3S towards the peripheral part (i.e. toward the short side 3S). On the other hand, the curvature along the major axis X gradually decreases from the minor axis Y towards an intermediate part and gradually increases from the intermediate part towards the peripheral part (i.e. towards the short side 3S) on the parallel axis X* that is located towards the long side 3L from the intermediate part on the minor axis Y.

In this case, the relationship between the distribution of curvatures on the major axis X and the distribution of curvatures on the parallel axis X* (Y=120) is expressed by
Cxp0<Cxpv, and Cxpd<Cxph
where Cxp0 is a curvature at the origin (0, 0), Cxpv is a curvature at point (0, 120), Cxph is a curvature at point (120, 0), and Cxpd is a curvature at point (120, 120). This relationship with the distribution of curvatures on the major axis X is maintained even if the distribution of curvatures on the parallel axis X* is replaced with the distribution of curvatures on the long side (3L).

The inner surface of the panel 3 is configured to satisfy the following relationship,
Zphi<Xphi²×Zpho/Xpho²
where Xpho is the distance between the origin (0, 0) on the major axis X and the end of the effective dimension; Zpho is a difference in height along the tube axis between the origin (0, 0) on the major axis X and the end of the effective dimension (Xpho, 0); and Zphi is a difference in height along the tube axis between the origin (0, 0) on the major axis X and a point (Xphi, 0).

FIG. 6 is a view for explaining the curved-surface shape of the inner surface of the panel. In the example shown in FIG. 6, the distance Xpho between the origin O (0, 0) on the inner surface of the panel and the end of the effective dimension on the major axis X (near the short side 3S) is about 200 mm. The difference in height, i.e. a depression amount, along the tube axis between the origin O and the end of the effective dimension (200, 0) is Zpho. In addition, the point (Xphi, 0) that is located in a region of 2/4 to ¾ of the distance from the origin O on the major axis X to the end (200, 0) of the effective dimension is set at a point (120, 0) where Xphi=120. The difference in height (depression amount) along the tube axis between the origin O on the major axis X and the point (120, 0) is Zphi. In this case, the above-described relationship can be established.

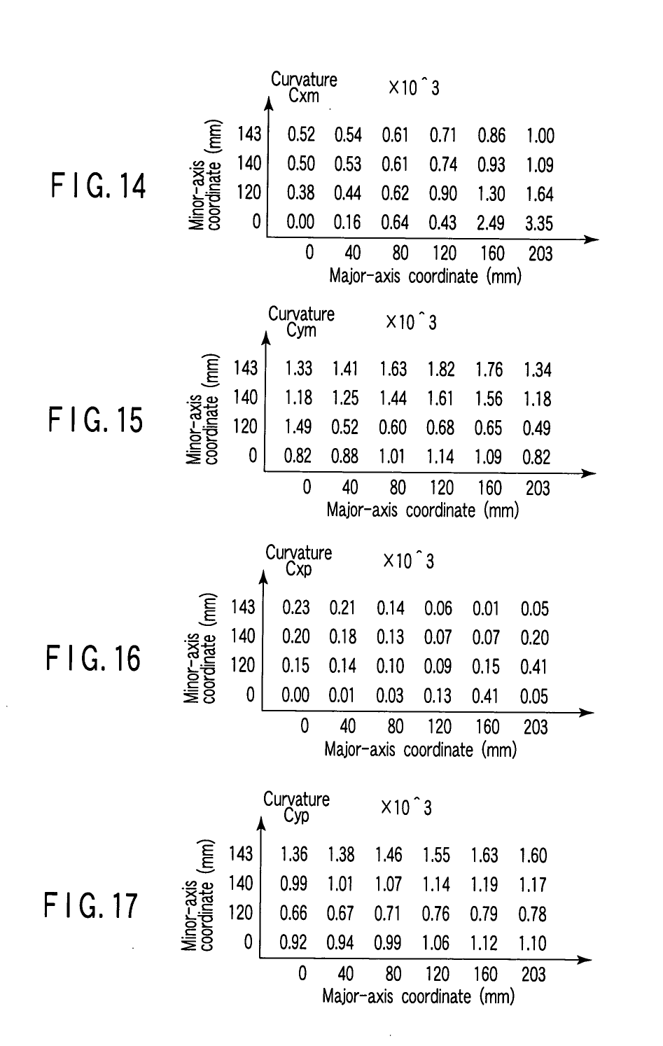

On the other hand, the shadow mask 9 can be fabricated in a shape that is substantially similar to the above-described inner surface shape of the panel 3. In this case, as regards the shadow mask 9, a curvature Cxm along the major axis H is set as shown in FIG. 14, and a curvature Cym along the minor axis V is set as shown in FIG. 15. In FIG. 14 and FIG. 15, the abscissa indicates positions on the major axis of the shadow mask and the ordinate indicates positions on the minor axis of the shadow mask. FIG. 14 and FIG. 15 show curvatures at the respective positions on the shadow mask. The shadow mask 9 has the major axis H and the minor axis V that intersect at right angles with each other. The curvature along the major axis H is set to satisfy the following relationships,
Cxm0<Cxmv, and Cxmd<Cxmh
where Cxm0 is a curvature at the origin (0, 0) where the major axis H and minor axis V intersect at right angles; Cxmv is a curvature at a point (0, Ymvi) that is located towards the long side 7L from a point of at least ¾ of the distance (about 150 mm in this example) between the origin (0, 0) on the minor axis V and the end of the effective dimension (i.e. long side 7L); Cxmh is a curvature at a point (Xmhi, 0) that is located in a region of 2/4 to ¾ of the distance (about 200 mm in this example) between the origin (0, 0) on the major axis H and the end of the effective dimension (i.e. short side 7S); and Cxmd is a curvature at a coordinate point (Xmhi, Ymvi).

FIG. 7 shows an example of a distribution of curvatures in a direction along the major axis H of the shadow mask 9. In FIG. 7, like FIG. 5, the abscissa indicates coordinate values (mm) on the major axis H, and the ordinate indicates the curvature (1/mm). The distribution of curvatures on the major axis H is indicated by a solid line, and the distribution of curvatures on a parallel axis H* that is parallel to the major axis H is indicated by a broken line. The parallel line H* is an axis that passes through a point (0, Ymvi) that is located towards the long side 7L from a point of at least ¾ of the distance between the origin on the minor axis V and the end of the effective dimension. In this example, the parallel axis H* is defined as an axis that passed through a point (0, 120) where Ymvi=120. In addition, in this example, the point (Xmhi, 0) that is located in a region of 2/4 to ¾ of the distance between the origin on the major axis H and the end of the effective dimension is set at a point (120, 0) where Xmhi=120, and the coordinate point (Xmhi, Ymvi) is set at a point (120, 120).

As is shown in FIG. 7, the curvature along the major axis H gradually increases from the origin (0, 0) towards the peripheral part (i.e. toward the short side 3S) on the major axis H (solid line). On the other hand, the curvature along the major axis X gradually increases from the minor axis V towards the peripheral part (i.e. towards the short side 3S) on the parallel axis H* that is located towards the long side 7L from the intermediate part on the minor axis V.

In this case, the relationship between the distribution of curvatures on the major axis H and the distribution of curvatures on the parallel axis H*(Y=120) is expressed by
Cxm0<Cxmv, and Cxmd<Cxmh
where Cxm0 is a curvature at the origin (0, 0), Cxmv is a curvature at point (0, 120), Cxmh is a curvature at point (120, 0), and Cxmd is a curvature at point (120, 120). This relationship with the distribution of curvatures on the major axis H is maintained even if the distribution of curvatures on the parallel axis H* is replaced with the distribution of curvatures on the long side (7L).

The shadow mask 9 is configured to satisfy the following relationship,
Zmhi<Xmhi²×Zmho/Xmho²
where Xmho is a distance between the origin (0, 0) on the major axis H and the end of the effective dimension; Zmho is a difference in height along the tube axis between the origin (0, 0) on the major axis H and the end of the effective dimension (Xmho, 0); and Zmhi is a difference in height along the tube axis between the origin (0, 0) on the major axis H and a point (Xmhi, 0).

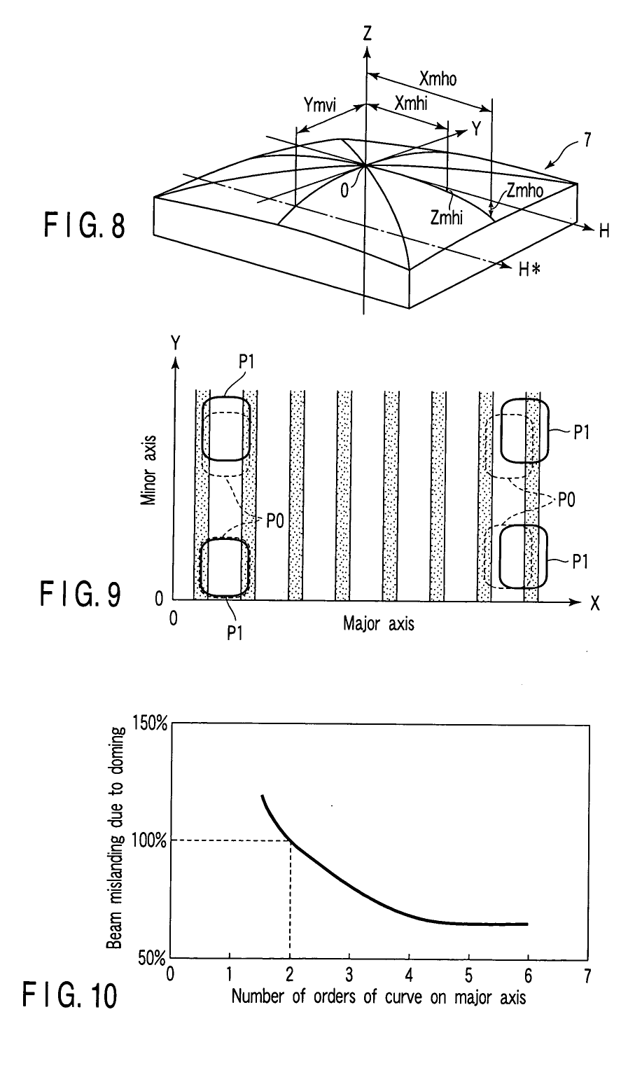

FIG. 8 is a view for explaining the curved-surface shape of the shadow mask. In the example shown in FIG. 8, the distance Xmho between the origin O (0, 0) on the mask body 7 and the end of the effective dimension on the major axis H (near the short side 7S) is about 200 mm. The difference in height, i.e. a depression amount, along the tube axis between the origin O and the end of the effective dimension (200, 0) is Zmho. In addition, the point (Xmhi, 0) that is located in a region of 2/4 to ¾ of the distance from the origin O on the major axis H to the end (200, 0) of the effective dimension is set at a point (120, 0) where Xmhi =120. The difference in height (depression amount) along the tube axis between the origin O on the major axis H and the point (120, 0) is Zmhi. In this case, the above-described relationship can be established.

The effect of doming occurring at the time of operation is considered with respect to a color cathode-ray tube to which the panel 3 and the shadow mask 9 that have the above-described relationships are applied.

The curvature of the central part of the panel 3 or mask body 7 is set at a relatively small value. Thereby, the amount of doming of the mask body 7 is intentionally increased. At this time, as shown in FIG. 9, a position P1, where an electron beam lands in the state in which doming is caused, is displaced only in the direction of minor axis Y from a position P0 where the electron beam should normally lands (or a position where the electron beam lands prior to occurrence of doming). The electron beam does not land on a neighboring phosphor layer of another color. Therefore, no degradation occurs in color purity. In short, at the central part of the screen, electron beam mislanding can be prevented regardless of the amount of doming, and the effect due to a decrease in curvature can be minimized.

On the other hand, the amount of electron beam mislanding increases in accordance with an increase in amount of doming, in the vicinity of the intermediate part of the panel 3 or mask body 7 (i.e. the region of 2/4 to ¾ of the distance from the origin on the major axis to the end of the effective dimension). At this time, as shown in FIG. 9, beam mislanding occurs and the color purity deteriorates. In other words, the position Pi, where the electron beam lands in the state in which doming is caused, is displaced both in the directions of major axis X and minor axis Y from the position P0 where the electron beam should normally land (or the position where the electron beam lands prior to occurrence of doming), and the electron beam lands on a neighboring phosphor layer of another color. Consequently, degradation occurs in color purity.

Thus, in the vicinity of the intermediate part, the curvature in the major-axis direction is set at a large value at a given point in the region of 2/4 to ¾ of the distance from the origin on the major axis to the end of the effective dimension, for instance, at a point of X=120. Thereby, the mechanical strength is increased, and the doming of the mask body 7 is suppressed. Therefore, mislanding of the electron beam is prevented and the degradation in color purity is suppressed.

At the same time, by increasing the curvature in the minor-axis direction, the doming suppressing effect can further be increased. Accordingly, the depression amount at the point of X=120 (mm) is minimized, and the above-described relationship, i.e.,
Zmhi<Xmhi²×Zmho/Xmho²
is satisfied.

For example, when the cross-sectional shape of the panel inner surface or mask body along its major axis is defined using a fourth-order function, the above relationship can be satisfied. In FIG. 10, the abscissa indicates the number of orders of the function that defines the cross-sectional shape on the major axis, and the ordinate indicates the amount of electron beam mislanding due to doming. It is assumed that the amount of mislanding in the case where the cross-sectional shape on the major axis is defined by the second-order function is set as a reference (100%). It was confirmed that the above-described relationship was satisfied and the amount of mislanding was successfully suppressed by defining the cross-sectional shape using a function of four or more orders.

On the shadow mask or the panel inner surface, the curvature along the minor axis at a point on the major axis is so set as to take a maximum value in a region of 2/4 to ¾ of the distance from the origin on the major axis to the end of the effective dimension. In other words, at a given point that is located toward the long side from at least ¾ of the distance between the origin on the minor axis and the end of the effective dimension, for instance, at a point of Y=120, the curvature in the major-axis direction is set to be less than that at the central part. This aims at reinforcing the curved surface of the mask at the intermediate part on the minor axis, whose mechanical strength is decreased when planarized, and at securing a sufficient depression amount at the intermediate part, e.g. at a coordinate point (120, 120). In this case, it is possible to secure a sufficient depression amount at the coordinate point (120, 120) and to sufficiently decrease the curvature along the minor axis. As a result, as shown in FIG. 11, the curvature along the minor axis at a point on the major axis takes a maximum value in a region of 2/4 to ¾ of the distance from the origin on the major axis to the end of the effective dimension.

For example, the curvature in the major-axis direction at a given coordinate point on the intermediate part, e.g. coordinate point (120, 120), is slightly less than the curvature at a point of Y=120 (mm) on the minor axis, but is set to be greater than the curvature at a point of X=120 (mm) on the major axis. The reason for this is as follows. If an axis that is parallel to the major axis, which passes through point Y=120 on the minor axis, is considered, the curvature at point Y=120 on the minor axis is set to be relatively large in order to obtain a large depression amount near the intermediate part. Hence, if the curvature is further increased, an inverted part would form in a region between the intermediate part and the end of the effective dimension. Such an inverted part is undesirable when a curved surface is to be formed, and it is difficult to obtain a desired curved surface. Besides, the pressure resistance of the curved surface decreases. It is necessary, therefore, to maintain the above relationship in order to secure a sufficient mechanical strength.

In the first embodiment, if the depression amount at the diagonal end part relative to the origin is made equal between the prior art and this first embodiment, the amount of electron beam mislanding due to doming is improved by about 35%, compared to the combination of the prior-art panel and shadow mask that are formed with the single curvature of 0.59×10³.

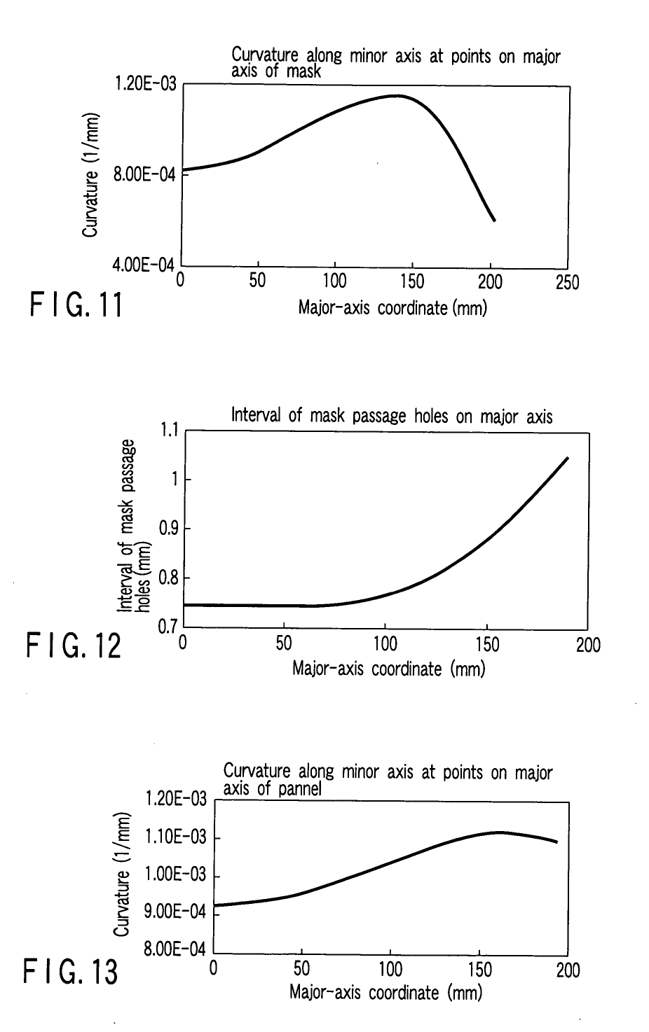

On the panel inner surface, if the curvature along the minor axis at a point on the major axis has a maximum value in the region of 2/4 to ¾ of the distance from the origin on the major axis to the end of the effective dimension, the effect is greatly reflected on the mask body, too, and this is advantageous. In this case, as shown in FIG. 12, the electron beam passage hole trains 6X formed in the mask body 7 may be arranged at substantially regular small intervals between the central part and the intermediate part. Thereby, as shown in FIG. 13, it becomes possible to prevent the curvature from having a maximum value. In this case, the panel inner surface and the curved surface of the shadow mask are uniformly formed and the visibility is improved.

It is desirable that on the mask body 7, the intervals of the electron beam passage hole trains 6X be set to satisfy the relationship,
PHI/PHC<1.08
where PHC is an interval at the central part, for example, at the origin, and PHI is an interval at a midpoint of ½ of the distance from the origin to the end of the effective dimension. In this example, PHI/PHC=1.04. On the side toward the end of the effective dimension from the midpoint, if the mask passage hole trains are set at small intervals, like the central part, the interval PHp between the same-color phosphor layers (see FIG. 2) becomes smaller on the phosphor screen 5. Consequently, the black non-emission layers 22K become similarly smaller, and the color purity would deteriorate in association with color misregistration due to doming at the time of operation of the color cathode-ray tube. Thus, it is preferable to set the intervals of electron beam passage hole trains at a value greater than the above range at the end of the effective dimension.

A color cathode-ray tube according to a second embodiment of the invention is configured as follows. By way of example, a description is given of a color cathode-ray tube wherein the diagonal effective diameter of the effective portion 1 is 59 cm, the aspect ratio is 4:3, and the radius of curvature of the outer surface of the panel is 30 m.

Like the first embodiment, the mask body 7 is formed of a material that essentially comprises iron with a thermal expansion coefficient of 12×10⁻⁶ in a temperature range of 0° C. to 100° C.

As regards the panel 3, a curvature Cxp along the major axis X is set as shown in FIG. 20, and a curvature Cyp along the minor axis Y is set as shown in FIG. 21. In FIG. 20 and FIG. 21, the abscissa indicates positions on the major axis of the panel and the ordinate indicates positions on the minor axis of the panel. FIG. 20 and FIG. 21 show curvatures at the respective positions on the panel.

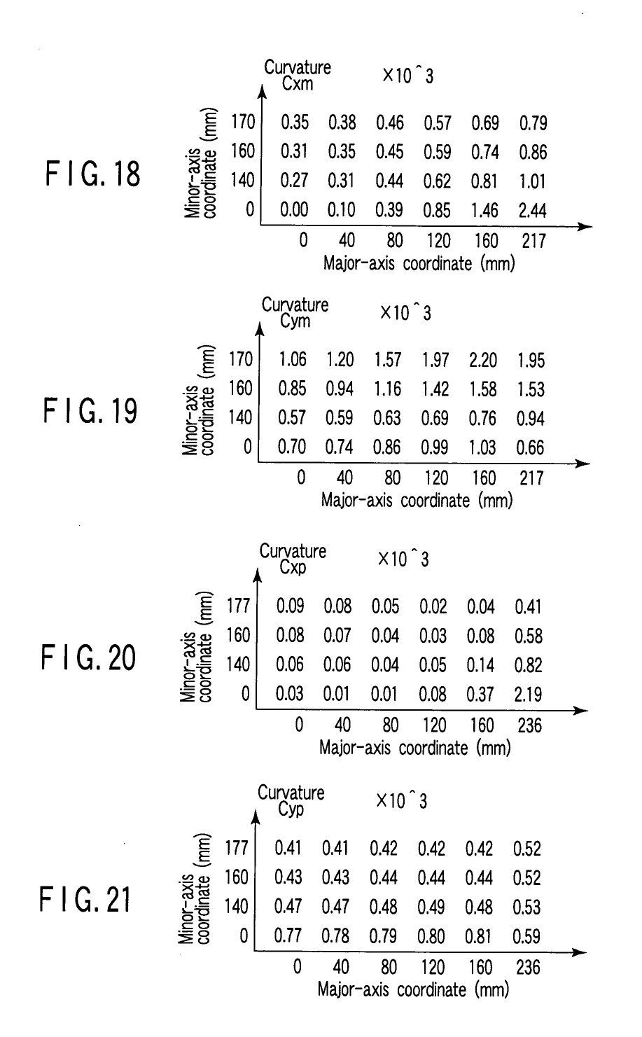

As regards the shadow mask 9, a curvature Cxm along the major axis H is set as shown in FIG. 18, and a curvature Cym along the minor axis V is set as shown in FIG. 19. In FIG. 18 and FIG. 19, the abscissa indicates positions on the major axis of the shadow mask and the ordinate indicates positions on the minor axis of the shadow mask. FIG. 18 and FIG. 19 show curvatures at the respective positions on the shadow mask.

In the second embodiment, too, if the depression amount at the diagonal end part relative to the origin is made equal between the prior art and this second embodiment, the amount of electron beam mislanding due to doming is improved by about 30%, compared to the combination of the prior-art panel and shadow mask that are formed with the single curvature of 0.51×10³.

In addition, in this case, when Xmhi=150, Zmhi=2.55 and Xmhi²×Zmho/Xmho²=5.18, and the following relationship is satisfied:
Zmhi<Xmhi²×Zmho/Xmho².

At this time, too, the relationship between the amount of mislanding and the number of orders is nearly equal to that shown in FIG. 10, and it is understood that doming can effectively be suppressed by maintaining the above relationship. As has been described, according to the cathode-ray tube relating to this embodiment, the shadow mask is formed of a material that essentially comprises relatively inexpensive iron. Since the curvature of the mask body or the panel inner surface is set at a proper condition, even where a material with a relatively high thermal expansion coefficient is used, the visibility, the performance in formation of the mask and the mechanical strength can be improved. In addition, doming of the mask body can be suppressed. Thereby, deterioration in color purity due to electron beam mislanding can be prevented.

In particular, in a cathode-ray tube in which the curvature of the panel outer surface is reduced to improve the visibility, the formation of a curved surface of the mask body is difficult and a desired curved surface cannot be obtained. Besides, due to local doming of the mask major surface, which occurs at the time of operation of a TV set including the cathode-ray tube, electron beam mislanding may occur and the electron beam tends to shift beyond the black non-emission layer and to cause the phosphor layer of the color, which is not the intended color for light emission, to emit light, leading to degradation in color purity. By contrast, in the present embodiment, the problems such as degradation in color purity can effectively be suppressed even in the case where the visibility, the performance in formation of the mask and the mechanical strength are improved. Therefore, it is possible to provide a color cathode-ray tube capable of improving display quality at low cost.

The present invention is not limited to the above-described embodiments. At the stage of practicing the invention, various embodiments may be made by modifying the structural elements without departing from the spirit of the invention. Structural elements disclosed in the embodiments may properly be combined, and various inventions may be made. For example, some structural elements may be omitted from the embodiments. Moreover, structural elements in different embodiments may properly be combined. For example, the present invention is applicable not only to color cathode-ray tubes with the aspect ratio of 4:3, but also to color cathode-ray tubes with the aspect ratio of 16:9.

The present invention can provide a color cathode-ray tube capable of improving display quality at low cost.

1. A cathode-ray tube comprising:
an envelope including a substantially rectangular panel with a substantially flat outer surface, and a funnel that is coupled to the panel;
a phosphor screen that is disposed on an inner surface of the panel;
an electron gun assembly that is disposed within the envelope and emits an electron beam towards the phosphor screen; and
a substantially rectangular shadow mask including a mask body, which is disposed to face the phosphor screen and has a plurality of electron beam passage holes, and a mask frame that supports a peripheral part of the mask body,
wherein the shadow mask is formed of a material that essentially comprises iron,
the shadow mask has a major axis and a minor axis that intersect at right angles with each other, and a curvature along the major axis is set to satisfy the following relationships,
Cxm0<Cxmv, and Cxmd<Cxmh
where Cxm0 is a curvature at an origin (0, 0) where the major axis and the minor axis intersect at right angles; Cxmv is a curvature at a point (0, Ymvi) that is located towards a long side from a point of at least ¾ of a distance from the origin on the minor axis to an end of an effective dimension; Cxmh is a curvature at a point (Xmhi, 0) that is located in a region of 2/4 to ¾ of a distance from the origin on the major axis to an end of an effective dimension; and Cxmd is a curvature at a coordinate point (Xmhi, Ymvi), and
the shadow mask is configured to satisfy the following relationship,
Zmhi<Xmhi²×Zmho/Xmho²
where Xmho is a distance between the origin on the major axis and the end of the effective dimension; Zmho is a difference in height along a tube axis between the origin on the major axis and the end (Xmho, 0) of the effective dimension; and Zmhi is a difference in height along the tube axis between the origin on the major axis and a point (Xmhi, 0).

2. The cathode-ray tube according to claim 1, wherein on the shadow mask, a curvature along the minor axis at a point on the major axis has a maximum value in a region of 2/4 to ¾ of the distance from the origin on the major axis to the end of the effective dimension.

3. The cathode-ray tube according to claim 1, wherein on the mask body, an interval of electron beam passage hole trains comprising a plurality of said electron beam passage holes, which are arranged along the minor axis, is set to satisfy the relationship,
PHI/PHC<1.08
where PHC is an interval at the origin, and PHI is an interval at a point of ½ of the distance from the origin to the end of the effective dimension.

4. A cathode-ray tube comprising:
an envelope including a substantially rectangular panel with a substantially flat outer surface, and a funnel that is coupled to the panel;
a phosphor screen that is disposed on an inner surface of the panel;
an electron gun assembly that is disposed within the envelope and emits an electron beam towards the phosphor screen; and
a substantially rectangular shadow mask including a mask body, which is disposed to face the phosphor screen and has a plurality of electron beam passage holes, and a mask frame that supports a peripheral part of the mask body,
wherein the inner surface of the panel has a major axis and a minor axis that intersect at right angles with each other, and a curvature along the major axis is set to satisfy the following relationships,
Cxp0<Cxpv, and Cxpd<Cxph
where Cxp0 is a curvature at an origin (0, 0) where the major axis and the minor axis intersect at right angles; Cxpv is a curvature at a point (0, Ypvi) that is located towards a long side from a point of at least ¾ of a distance from the origin on the minor axis to an end of an effective dimension; Cxph is a curvature at a point (Xphi, 0) that is located in a region of 2/4 to ¾ of a distance from the origin on the major axis to an end of an effective dimension; and Cxpd is a curvature at a coordinate point (Xphi, Ypvi), and
the inner surface of the panel is configured to satisfy the following relationship,
Zphi<Xphi²×Zpho/Xpho²
where Xpho is a distance between the origin on the major axis and the end of the effective dimension; Zpho is a difference in height along a tube axis between the origin on the major axis and the end (Xpho, 0) of the effective dimension; and Zphi is a difference in height along the tube axis between the origin on the major axis and a point (Xphi, 0).

5. The cathode-ray tube according to claim 4, wherein on the inner surface of the panel, a curvature along the minor axis at a point on the major axis has a maximum value in a region of 2/4 to ¾ of the distance from the origin on the major axis to the end of the effective dimension.

6. The cathode-ray tube according to claim 4, wherein on the mask body, an interval of electron beam passage hole trains comprising a plurality of said electron beam passage holes, which are arranged along the minor axis, is set to satisfy the relationship,
PHI/PHC<1.08
where PHC is an interval at the origin, and PHI is an interval at a point of ½ of the distance from the origin to the end of the effective dimension.
